(19) United States
(12) Patent Application Publication
(10) Pub. No.: US 2016/0124801 A1
(43) Pub. Date: May 5, 2016

(54) COMPONENT STATE MANAGEMENT METHOD FOR COMPONENT BASED SOFTWARE AND APPARATUS THEREOF

(71) Applicant: ELECTRONICS AND TELECOMMUNICATIONS RESEARCH INSTITUTE, Daejeon (KR)

(72) Inventors: Kang-Woo LEE, Daejeon (KR); Hyoung-Sun KIM, Daejeon (KR)

(21) Appl. No.: 14/926,947

(22) Filed: Oct. 29, 2015

(30) Foreign Application Priority Data
Oct. 31, 2014 (KR) 10-2014-0150424

(51) Int. Cl. G06F 11/07

(52) U.S. Cl. CPC G06F 11/0793; G06F 11/0751; G06F 11/0772; G06F 11/079

(57) ABSTRACT

Exemplary embodiments of the present invention relate to component state management method for component-based software and apparatus thereof A component state management method for component-based software according to an embodiment of the present invention comprises: detecting state transition of at least one property component while in a running state an upper component and property components which are referred by the upper component are driving; when state transition of the at least one property component is detected, determining whether the state transitioned property component is essential to drive the upper component; determining, based on the determined result, whether state transition of the upper component is to be made. According to exemplary embodiments of the present invention, even though some of components do not operate due to a failure, a system may operate without interruption.

### CROSS REFERENCE TO RELATED APPLICATION

This application claims the benefit of Korean Patent Application No. 10-2014-0150424, filed on Oct. 31, 2014, which is hereby incorporated by reference in its entirety into this application.

### BACKGROUND

1. Technical Field

Exemplary embodiments of the present invention relate to a method and apparatus for managing component state of component-based software.

2. Description of the Related Art

Software, which is being developed now days, has been developed by utilizing components to improve reusability and productivity. The software is called as component-based software. The component-based software is designed to separate a system into several components and combine the components. In a process of implementing the component-based software, already developed components can be reused and only the least components are separately developed.

When the component-based software is used, it provides high software reusability and productivity. However, when a fault is occurred in any one of components and thus does not work, an entire system must be stopped. Particularly, when software operates in distributed environments and software is implemented by combining components distributed in several sites, such problems occur more often.

### SUMMARY

Exemplary embodiments of the present invention allow continuous operation of component-based software even though some of components are failed.

Exemplary embodiments of the present invention provide a component state management method for component-based software.

A component state management method for component-based software according to an embodiment of the present invention comprises detecting state transition of at least one property component while in a running state in which an upper component and property components which are referred by the upper component are driving; when state transition of the at least one property component is detected, determining whether the state transitioned property component is essential to drive the upper component; determining, based on the determined result, whether state transition of the upper component is to be made.

The method may further comprise maintaining running state of the upper component when it is determined as that the state transitioned property component is not essential to drive the upper component.

The method may further comprise allowing a state of the upper component to be transitioned from the driving state to a property setting state to re-set property components to be referred when it is determined as that the state transitioned property component is essential to drive the upper component.

The method may further comprise allowing a state of the upper component to be transitioned from the property setting state to an initializing state for initialization when re-setting of property components to be referred by the upper component is completed.

The method may further comprise allowing a state of the upper component to be transitioned from the initializing state to the running state when the initialization is completed.

The method may further comprise returning a pre-allocated resource for the component transitioned to the property setting state.

The method may further comprise allowing a state of a component in which fault is occurred in at least one state of the property setting state, the initializing state and the running state to be transitioned to a failed state. In an embodiment, the method may further comprise allowing a state of a component in which fault is recovered in the failed state to be transitioned to the property setting state.

The method may further comprise allowing a state of a component selected by a user among the property setting state, the initializing state and the running state to be transitioned to a deactivated state. In an embodiment, the method may further comprise allowing a state of a component selected by the user in the deactivated state to be transitioned to the property setting state. In an embodiment, the method may further comprise returning a pre-allocated resource for the component transitioned to the deactivated state.

A component state management apparatus for component-based software according to an embodiment of the present invention comprises a drive module configured to drive an upper component and property components which are transitioned to running state in which the upper component and the property components are driving; a state transition detecting module configured to detect state transition of at least one property component which is in running state; and a state transition module configured to determine whether a state transitioned property component is essential to drive the upper component by referring to preset information when state transition of the at least one property component is detected, and determine, based on the determined result, whether state transition of the upper component is to be made.

The state transition module may maintain running state of the upper component when it is determined as that the state transitioned property component is not essential to drive the upper component.

The state transition module may allow a state of the upper component to be transitioned from the driving state to a property setting state to re-set property components to be referred when it is determined as that the state transitioned property component is essential to drive the upper component.

The state transition module may allow a state of the upper component to be transitioned from the property setting state to an initializing state for initialization when re-setting of property components to be referred by the upper component is completed.

The state transition module may allow a state of the upper component to be transitioned from the initializing state to the running state when the initialization is completed.

The state transition module may return a pre-allocated resource for the component transitioned to the property setting state.

The state transition module may allow a state of a component in which fault is occurred in at least one state of the property setting state, the initializing state and the running state to be transitioned to a failed state. In an embodiment, the state transition module may allow a state of a component in which fault is recovered in the failed state to be transitioned to the property setting state.

The state transition module may allow a state of a component selected by a user among the property setting state, the initializing state and the running state to be transitioned to a deactivated state. In an embodiment, the state transition module may allow a state of a component selected by the user in the deactivated state to be transitioned to the property setting state. In an embodiment, the state transition module may return a pre-allocated resource for the component transitioned to the deactivated state.

A component state management apparatus comprising a processor and a memory according to an embodiment of the present invention may store commands to manage state of components for component-based software in the memory, wherein when it is executed by the processor, the commands may comprise commands for the processor to detect state transition of at least one the property component while in a running state in which an upper component and property components which are referred by the upper component are running; to determine whether a state transitioned property component is essential to drive the upper component by referring to preset information when state transition of the at least one property component is detected; and to determine, based on the determined result, whether state transition of the upper component is to be made.

In an embodiment, the commands may comprise commands for the processor to maintain running state of the upper component when it is determined as that the state transitioned property component is not essential to drive the upper component and to allow a state of the upper component to be transitioned from the driving state to a property setting state to re-set property components to be referred, when it is determined as that the state transitioned property component is essential to drive the upper component.

According to exemplary embodiments of the present invention, a system may continuously operate without interruption even when some of components are failed. According to exemplary embodiments of the present invention, a component may be replaced dynamically to improve performance and functionality during system operation. According to exemplary embodiments of the present invention, when some of components are stopped, flexibility of a system may be improved by providing appropriate coping skills.

### BRIEF DESCRIPTION OF DRAWING

FIG. 1 is a block view illustrating component-based software in which an embodiment of the present invention is applied.

FIG. 2 illustrates a function which a component according to an embodiment of the present invention provides.

FIG. 3 illustrates transitioning states according to an embodiment of the present invention.

FIG. 4 is a flowchart illustrating a state transition process of components according to an embodiment of the present invention.

FIG. 5 is a block view illustrating functional structure of a component manager according to an embodiment of the present invention.

FIG. 6 is a block view illustrating a component state management apparatus according to an embodiment of the present invention.

### DESCRIPTION OF THE EXEMPLARY EMBODIMENTS

Throughout the description of the present invention, when describing a certain technology is determined to evade the point of the present invention, the pertinent detailed description will be omitted.

Exemplary embodiments of the present invention define transitioning states of component which are required to load, eliminate, connect and disconnect components and provide operations which is required when state transition is occurred.

Exemplary embodiments of the present invention provide functions which components should have for dynamic management of the components.

Exemplary embodiments of the present invention will be described with reference to the accompanying drawings.

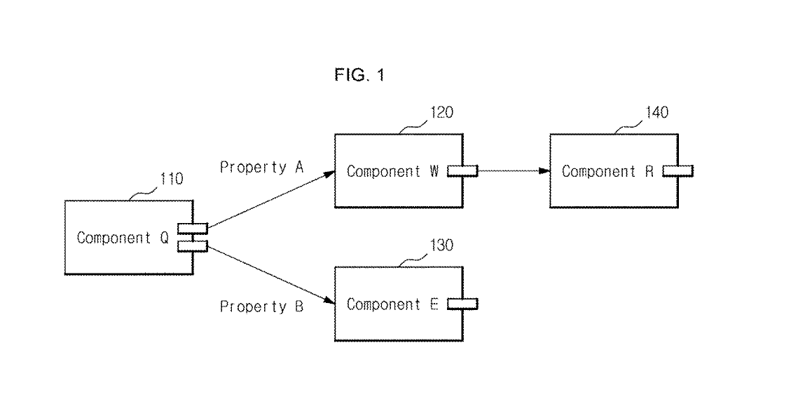

FIG. 1 is a block view illustrating component-based software in which an embodiment of the present invention is applied.

Component-based software may be composed with at least one component, and connection between a referred component and a referring component may be formed. Connection between components is a directed graph type and has a direction from the referring component to the referred component.

For example, as shown in FIG. 1, a component W 120 and a component E 130 are referred by a component Q 110, and a component R 140 is referred by the component W 120 in the component-based software.

Connection between components is set in a way that a unique identifier of a referred component is stored with a property value of a referring component.

For example, as shown in FIG. 1, the component Q 110 has connection toward the component W 120 through a property A and has connection toward the component E 130 through a property B in the component-based software.

Calling, state transitioning and driving of such components may be performed by a component manager. The component manager may be a module which executes in a processor and may be an independent program or a part of program.

As described above, the entire system may be malfunctioned or stopped working in the component-based software, when a fault is occurred in any one component.

For example, when the component R 140 in FIG. 1 is failed in operating, it may cause a problem to the component W 120 which refers to the component R 140 and further cause a problem to the component Q 110.

If the component-based software can operate in another way without the component R 140, the component manager may handle by notifying this situation to the component W 120. For example, when the component R 140 does not affect to an operation of the component W 120 significantly, the component manager may notify the situation that the component R 140 does not work properly to the component W 120. The component W 120 may then do not refer to the component R 140 or may discard information which is obtained from the component R 140. According to an embodiment of the present invention, the system may be flexible in dealing with, without interruption, even such a situation that any one of components is failed in working.

For example, it is assumed that a ‘human recognition’ component operates by referring to a ‘face recognition’ component and a ‘body recognition’ component. Result of operation of the ‘face recognition’ component may affect operation of the ‘human recognition’ component, but if there is no problem in operation of the ‘human recognition’ component only with the operation result from the ‘body recognition’ component, the ‘human recognition’ component is able to operate recognition by referring to only the ‘body recognition’ component even though the ‘face recognition’ component is failed in operating.

In addition, when the component R 140 re-starts to operate, the component manager may notify this fact to the component W 120 to allow the system to be uninterrupted. Here, the component W 120 may re-start to refer to the component R 140 or operate by using information obtained from the component R 140.

As described above, exemplary embodiments of the present invention do not cause any system discontinuance by providing dynamical property connections between components. It is thus required to manage functions which components provide, component states and state transition processes, and operation processes of the component manager.

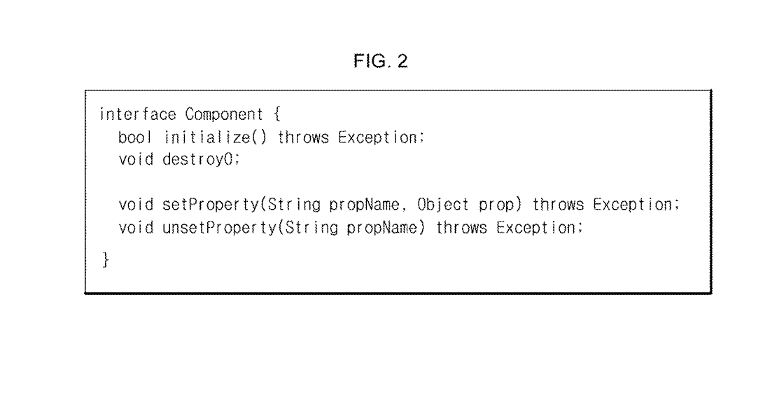

FIG. 2 illustrates a function which a component according to an embodiment of the present invention provides. FIG. 2 illustrates a function which a component provides using a java interface.

Components may provide an initialize function and a destroy function.

The initialize function may be called after all properties, which are needed for an operation of each component, are determined and the component which is completed for initialization may be referred by another component.

The destroy function may be called, during a process of deactivation of a component, to return resources which are used for an operation of the component.

The component may provide a function (setProperty) to set a necessary property and a function (unsetProperty) to unset the component which is set with the property.

The functions may be called at an appropriate time by the component manager. The functions will be explained below with reference to the relating drawings.

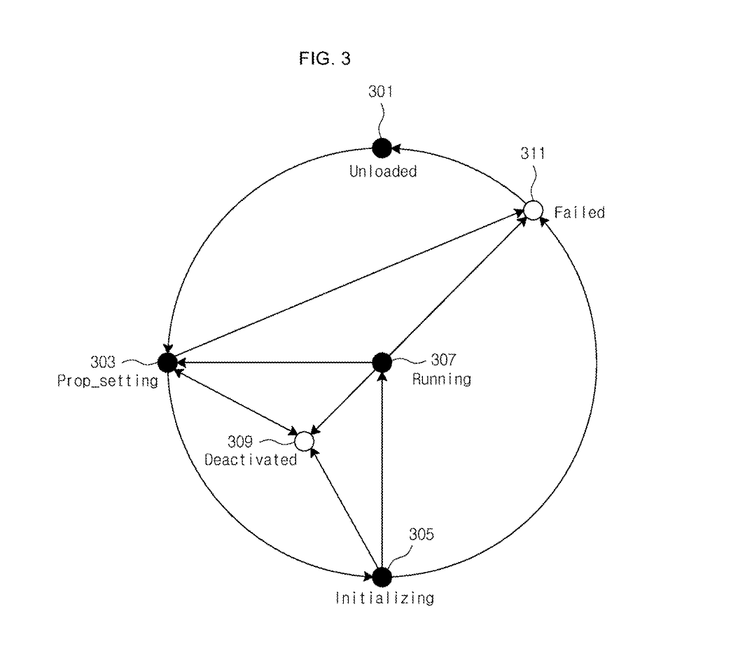

FIG. 3 illustrates transitioning states according to an embodiment of the present invention.

An unloaded state 301 is an initial state before any component is loaded. When a component is loaded by the component manager, a state of the component is transitioned to a property setting state 303.

The property setting state 303 is a standby state in which properties are to be set to the loaded component. The component in the property setting state may not be referred by another component. Property setting may be carried through a ‘setProperty( )’ method. When property setting is completed by a user(which may be a program developer), a state of the component may be transitioned to an initializing state 305.

When any error occurs in the property setting state, a state of the corresponding component may be transitioned to a failed state 311. When the user orders deactivation of a component in the property setting state, a state of the corresponding component may be transitioned to a deactivated state 309.

The initializing state 305 is a state to perform initialization of a component by using a property value after the property value, which is required for the component to perform, is set. The component manager may try initialization for all components in the initializing state 305 by calling the ‘initialize( )’ method. A state of the initialized component of which a call return value is ‘true’ may transitioned to a running state 307.

When the call return value for the ‘initialize( )’ method is ‘false’, a corresponding component may be maintained in the initializing state 305 and the ‘initialize( )’ method may be called again by the component manager.

When any exception occurs during performing the ‘initialize( )’ method, a state of the corresponding component may be transitioned to the failed state 311. When the user orders deactivation of a component in the initializing state, a state of the corresponding component may be transitioned to the deactivated state 309.

When a state of at least one property component among property components referred by an upper component in the initializing state is transitioned to another state, a state of the upper component may be transitioned to the property setting state.

The running state 307 is a state in which functions of a component are operating after all properties needed to operate the component are set and initialization is successively completed. When a state of at least one property component is transitioned to another state (for example, state transition from the running state 307 to the failed state 311) while the upper component is running, the upper component may be transitioned to the property setting state 303 to set properties. State transition to the property setting state 303 may be carried by calling the ‘unsetProperty( )’ method. Here, the component manager may let the resource, allocated when an ‘initialize( )’ function is called for the corresponding component, be returned by calling a ‘finalize( )’ function.

Even though a state of at least one property component is transitioned to another state while the upper component is running, if the at least one property component is not essential component to run the upper component, the running state 307 of the upper component may be maintained.

When an error occurs in the running state, a state of the corresponding component may be transitioned to the failed state 311. When the user orders deactivation of a component in the running state, a state of the corresponding component may be transitioned to the deactivated state 309.

The deactivated state 309 is a state in which a component is deactivated by the user. State transition to the deactivated state 309 may occur in at least one state of property setting state 303, initializing state 305 and running state 307.

The deactivated state 309 may be maintained till an activation is requested by the user. When the activation is requested by the user, a state of the component is transitioned to the property setting state 303.

The failed state 311 is a state in which a component cannot operate due to failure of the component or the like. Fault recovery by the user may be required in the failed state 311. When the fault is recovered, a state of the component may be transitioned to property setting state 303 through the unloaded state 301.

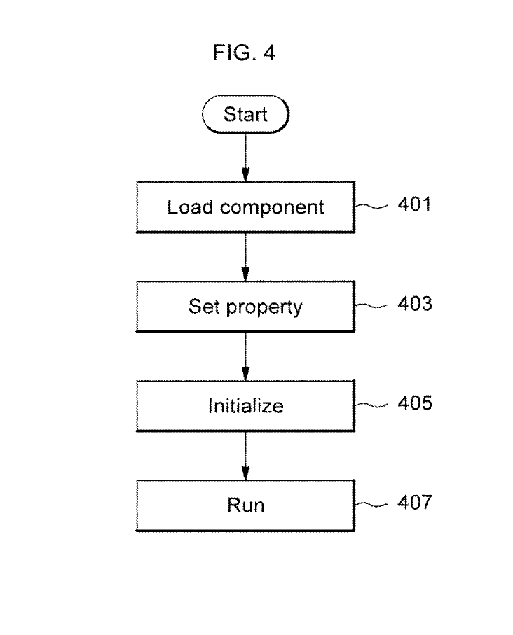

FIG. 4 is a flowchart illustrating a state transition process of components according to an embodiment of the present invention.

In Step 401, the component manager loads components. State of the loaded components may be transitioned from the unloaded state to the property setting state by the component manager.

In Step 403, the component manager sets properties for the components in the property setting state based on user's input. Setting properties may be carried by calling the ‘setProperty( )’ method and a state of component of which setting properties are completed may be transitioned to the initializing state by the component manager.

When there is a component in which an error occurs during the property setting, the component manager may allow a state of the component to be transitioned to the failed state. When the user orders deactivation of a component in the property setting state, the component manager may allow a state of the component to be transitioned to the deactivated state.

In Step 405, the component manager performs initialization for the components in the initializing state. The initialization may be carried by calling the ‘initialize( )’ method and state of the components of which initialization is completed may be transitioned to the running state by the component manager.

When there is a component of which call return value for the ‘initialize( )’ method is ‘false’, the component manager may maintain the initializing state for the corresponding component and call again the ‘initialize( )’ method.

When there is a component in which exception occurs during performing the method, the component manager may allow a state of the component to be transitioned to the failed state.

When the user orders deactivation of a component in the initializing state, the component manager may allow a state of the component to be transitioned to the deactivated state.

In Step 407, the component manager runs the components in the running state.

When it is detected that a state of at least one property component is transitioned to another state while the upper component is running, the component manager may maintain the running state of the upper component or allow a state of the upper component to be transitioned to the property setting state based on the fact whether the property component is an essential component to run the upper component.

Preset information may be used to determine whether the component is essential to run the upper component. The preset information may be, for example, inputted by the user in the property setting state. The preset information may, for example, include information about whether property components referred by the upper component are optional or essential to run the upper component.

When it is determined as that state transitioned property component is not essential to run the upper component, the component manager may maintain the running state of the upper component.

When it is determined as that state transitioned property component is essential to run the upper component, the component manager may allow a state of the upper component to be transitioned to the property setting state to re-set property components to be referred. State transition to the property setting state may be carried by calling the ‘unsetProperty( )’ method. Here, the component manager may return a resource which is allocated for the property component by calling the ‘finalize( )’ function.

When there is a component in which an error is occurs during operation, the component manager may allow a state of the component to be transitioned to the failed state 311. When the user orders deactivation of a component in the running state, the component manager may allow a state of the component to be transitioned to the deactivated state.

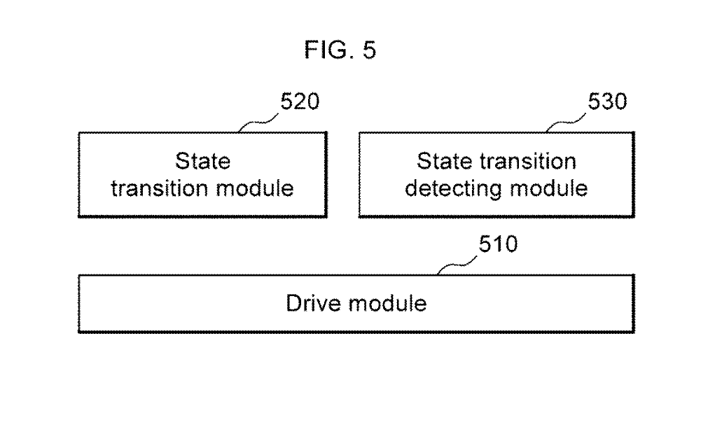

FIG. 5 is a block view illustrating functional structure of a component manager according to an embodiment of the present invention.

The component manager according to exemplary embodiments of the present invention may comprise a drive module 510, a state transition module 520 and a state transition detecting module 530. At least one of elements may be omitted.

The drive module 510 may drive components which are transitioned to the running state. The components may include an upper component and at least one property component which is referred by the upper component.

The state transition module 520 may, when a notification of state transition of a property component is received from the state transition detecting module 530, determine whether the state transitioned property component is essential to run the upper component by referring preset information and determine whether state transition of the upper component is needed or not based on the determined result.

The preset information may be inputted by the user in the property setting state. For example, the preset information may include information about whether property component for an upper component is essential or optional to run the upper component

When it is determined as that the state transitioned property component is not essential to drive the upper component based on the determined result, the state transition module 520 may maintain the running state of the upper component.

On the other hand, when it is determined as that the state transitioned property component is essential to drive the upper component based on the determined result, the state transition module 520 may allow a state of the upper component to be transitioned to the property setting state to re-set property components to be referred. Here, the state transition module 520 may return a resource which is pre-allocated for the state transitioned property component.

When re-setting components to be referred by the upper component in the property setting state is completed, the state transition module 520 may allow a state of the upper component to be transitioned to the initializing state. The state transition module 520 may allow a state of the upper component, of which initialization is completed in the initializing state, to be transitioned to the running state.

On the other hand, the state transition module 520 may allow a state of a component, which is failed in at least one state of the property setting state, the initializing state and the running state, to be transitioned to the failed state. When failure of the component which is transitioned to the failed state is recovered, the state transition module 520 may allow a state of the component to be transitioned to the property setting state.

The state transition module 520 may allow a state of a component which is selected by the user in any state of the property setting state, the initializing state and the running state to be transitioned to the deactivated state. Here, the state transition module 520 may let a resource, which is allocated for the component to be transitioned to the deactivated state, be returned. The state transition module 520 may allow a state of a component, which is selected by the user among the components in the deactivated state for activation, to be transitioned to the property setting state.

The state transition detecting module 530 may detect state transition of a component and notify the detected information to at least one of the state transition module 520 and another component. For example, when state transition of property component which is in the running state is detected, the state transition detecting module 530 may notify the detected result to the upper component and the state transition module 520.

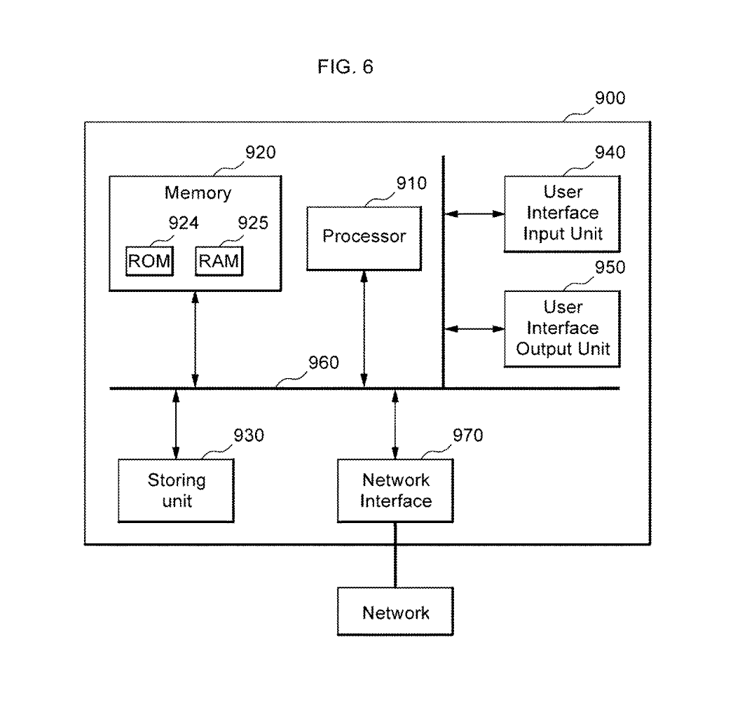

Exemplary embodiments of the present invention may be implemented in a computer system, for example, a computer readable recording medium. As shown in FIG. 6, a computer system 900 may include at least one of at least one processor 910, a memory 920, a storing unit 930, a user interface input unit 940 and a user interface output unit 950. The computer system 900 may further include a network interface 970 to connect to a network. The processor 910 may be a CPU or semiconductor device which executes processing commands stored in the memory 920 and/or the storing unit 930. The memory 920 and the storing unit 930 may include various types of volatile/non-volatile storage media. For example, the memory may include ROM 924 and RAM 925.

Accordingly, exemplary embodiments of the present invention may be implemented by a method implemented with a computer or by a non-volatile computer recording medium in which computer executable commands are stored. The commands may be performed by at least one embodiment of the present invention when they are executed by the processor.

What is claimed is:

1. A component state management method comprising:
detecting state transition of at least one property component while in a running state in which an upper component and property components which are referred by the upper component are driving;
when state transition of the at least one property component is detected, determining whether the state transitioned property component is essential to drive the upper component;
determining, based on the determined result, whether state transition of the upper component is to be made.

2. The component state management method of claim 1, further comprising maintaining running state of the upper component when it is determined as that the state transitioned property component is not essential to drive the upper component.

3. The component state management method of claim 1, further comprising allowing a state of the upper component to be transitioned from the driving state to a property setting state to re-set property components to be referred when it is determined as that the state transitioned property component is essential to drive the upper component.

4. The component state management method of claim 3, further comprising allowing a state of the upper component to be transitioned from the property setting state to an initializing state for initialization when re-setting of property components to be referred by the upper component is completed.

5. The component state management method of claim 4, further comprising allowing a state of the upper component to be transitioned from the initializing state to the running state when the initialization is completed.

6. The component state management method of claim 3, further comprising returning a pre-allocated resource for the component transitioned to the property setting state.

7. The component state management method of claim 4, further comprising
allowing a state of a component in which fault is occurred in at least one state of the property setting state, the initializing state and the running state to be transitioned to a failed state; and
allowing a state of a component in which fault is recovered in the failed state to be transitioned to the property setting state.

8. The component state management method of claim 4, further comprising allowing a state of a component selected by a user among the property setting state, the initializing state and the running state to be transitioned to a deactivated state; and
allowing a state of a component selected by the user in the deactivated state to be transitioned to the property setting state.

9. The component state management method of claim 8, further comprising returning a pre-allocated resource for the component transitioned to the deactivated state.

10. A component state management apparatus comprising:
a drive module configured to drive an upper component and property components which are transitioned to running state in which the upper component and the property components are driving;
a state transition detecting module configured to detect state transition of at least one property component which is in running state; and
a state transition module configured to determine whether a state transitioned property component is essential to drive the upper component by referring to preset information when state transition of the at least one property component is detected and determine, based on the determined result, whether state transition of the upper component is to be made.

11. The component state management apparatus of claim 10, wherein the state transition module maintains running state of the upper component when it is determined as that the state transitioned property component is not essential to drive the upper component.

12. The component state management apparatus of claim 10, wherein the state transition module allows a state of the upper component to be transitioned from the driving state to a property setting state to re-set property components to be referred when it is determined as that the state transitioned property component is essential to drive the upper component.

13. The component state management apparatus of claim 12, wherein the state transition module allows a state of the upper component to be transitioned from the property setting state to an initializing state for initialization when re-setting of property components to be referred by the upper component is completed.

14. The component state management apparatus of claim 13, wherein the state transition module allows a state of the upper component to be transitioned from the initializing state to the running state when the initialization is completed.

15. The component state management apparatus of claim 12, wherein the state transition module returns a pre-allocated resource for the component transitioned to the property setting state.

16. The component state management apparatus of claim 13, wherein the state transition module allows a state of a component in which fault is occurred in at least one state of the property setting state, the initializing state and the running state to be transitioned to a failed state; and allows a state of a component in which fault is recovered in the failed state to be transitioned to the property setting state.

17. The component state management apparatus of claim 13, wherein the state transition module allows a state of a component selected by a user among the property setting state, the initializing state and the running state to be transitioned to a deactivated state; and allows a state of a component selected by the user in the deactivated state to be transitioned to the property setting state.

18. The component state management apparatus of claim 17, wherein the state transition module returns a pre-allocated resource for the component transitioned to the deactivated state.
